(19) United States
(12) Patent Application Publication
(10) Pub. No.: US 2010/0024934 A1
(43) Pub. Date: Feb. 4, 2010

(54) MECHANISM BASED REACTIVE PLANAR SUSPENSION

(76) Inventors: AMIR KHAJEPOUR, Waterloo (CA); Geoffrey Boyer, Montreal (CA); Nasser Lashgarian Azad, Kitchener (CA)

Correspondence Address: Dickinson Wright PLLC., Suite 2000, 38525 Woodward Avenue, Bloomfield Hills, MI, 48304-5092, US

(21) Appl. No.: 12/183,963

(22) Filed: Jul. 31, 2008

(51) Int. Cl. B60B 9/02

(52) U.S. Cl. 152/17

(57) ABSTRACT

A suspension for a wheel rotatably mounted about an axle, comprising means to resiliently support the axle from movement in the plane of the wheel's rotation in response to an input to the wheel.

### FIELD OF THE INVENTION

The present invention relates generally to a suspension system for the wheel of a vehicle such as a bicycle, automobile or wheelchair, and more particularly to a suspension that resiliently supports the wheel's axle in the plane of wheel rotation within the suspension limits.

### BACKGROUND OF THE INVENTION

Vehicle suspensions today use some sort of fixed linear and/or curved planar travel path. This includes suspensions directly or indirectly coupled to a spring and/or dampener, suspensions directly or indirectly coupled to a frame, and/or chassis, and passive and/or adaptive suspensions. When a conventional vehicle suspension is compressed, due to a wheel of the vehicle impacting an obstacle, for example, the axle of the vehicle always travels the same path. For purposes of this description, the path that an axle follows during suspension compression is called the “travel path”.

Powered wheelchairs are configured as either mid-drive or rear drive. Typically the drive wheel has no suspension at all. The main drive wheel tire is either air filled or foam filled. In either case, the ride and shocks caused to the occupant can cause injury and discomfort. Further, the rider can have a difficult time maneuvering the wheelchair. Going over any type of surface other than a smooth surface can be challenging.

It is rare that a vehicle only encounters one impact or simple disturbance when traversing an obstacle or “input”. Instead, a wheel is likely to encounter impacts that do not coincide with the travel path. The problem with prior art suspensions is that they do not effectively absorb loads resulting from such impacts. Typically, when a vehicle impacts an obstacle, the orientation of the impact force changes throughout the vehicle suspension's travel path and therefore only a small portion of the travel is truly effective to absorb the impact's energy. Ideally, a truly effective suspension provides a vehicle frame and/or chassis with an ideal path to absorb a load under dynamic disturbance, and the suspension would further dissipate that load in a manner which would provide the occupant in the vehicle a more comfortable, stable platform.

### SUMMARY OF THE INVENTION

Accordingly, it is an object of the present invention to provide an improved reactive suspension system that obviates and mitigates from the disadvantages and limitations of the prior art.

One objective of the present invention is to provide a suspension with a travel path that can move with at least two degrees of freedom.

Another objective of the present invention is to provide a suspension which can be incorporated within one or more wheels of a vehicle.

Another objective of the present invention is to provide a suspension system which can absorb more of a vehicle's load disturbances than conventional suspension systems combinations are able to absorb.

Another objective in a preferred embodiment of the present invention is to provide a suspension system which allows a vehicle to use a harder tire with a lower profile without sacrificing comfort or performance.

Yet another objective in a preferred embodiment of the present invention is to provide a suspension system that can be placed in series with a conventional suspension, or be used in place of, or as part of, a conventional suspension.

Yet another objective in a preferred embodiment of the present invention is to provide a suspension that reduces the unsprung mass of a vehicle.

One or more of the stated objectives is accomplished by a novel suspension system for any type of ground, air, space or marine vehicle. The suspension is a system wherein, during suspension compression, a vehicle wheel's axle is allowed travel in a reactive travel path with at least two degrees of freedom. This reactive travel path distinguishes the present invention from the fixed linear or fixed curved travel paths of the prior art suspensions.

The present suspension has significant advantages over prior art suspensions. While conventional suspensions restrict a vehicle's axle to a single or fixed path, the current suspension allows the vehicle's axle to travel any two-dimensional path. The axle travel path of the current suspension is determined by the input, i.e. for any given input, the suspension responds with the travel path that best absorbs the energy of the input.

Since a vehicle's axle is not restricted to a defined travel path, like fixed linear or fixed curved path, the current suspension can react to a new input at any point of a travel path and create a new reactive travel path. Additionally, since the recovery travel of the suspension is not tied to the impact path, the suspension can recover faster than prior art suspensions.

The current suspension can be embedded in a wheel of any type, thereby packaging the suspension inside the wheel. When the suspension is embedded within a vehicle's wheels or wheel hubs, the unsprung mass of the vehicle is reduced because only the mass of the wheels is unsprung mass.

According to the present invention then, there is provided a suspension for a wheel rotatably mounted about an axle, comprising means to resiliently support said axle from movement in the Y and Z axes, or in the plane of wheel rotation, of said wheel in response to an input to said wheel.

### BRIEF DESCRIPTION OF THE DRAWINGS

Preferred embodiments of the present invention will now be described in greater detail and will be better understood when read in conjunction with the following drawings in which:

FIG. 1 is schematical representation of a wheel mounted in a conventional suspension;

FIG. 2 is a schematical representation of a suspension in accordance with one aspect of the present invention;

FIGS. 3A-3B are schematical illustrations comparing the travel path of conventional suspensions to a possible travel path of the present suspension;

FIG. 4 is a perspective view of a wheel having a suspension in accordance with another aspect of the present invention;

FIG. 5 is a perspective exploded view of a joint forming part of the suspension of FIG. 4;

FIG. 6 is a perspective view of another embodiment of the invention.

FIG. 7 is a schematic depiction of the embodiment shown in FIG. 6.

FIG. 8 is an exploded view of the embodiment shown in FIG. 6.

FIGS. 9-13 depict some of the components used with the embodiment shown in FIG. 6.

### DETAILED DESCRIPTION OF THE PREFERRED EMBODIMENTS

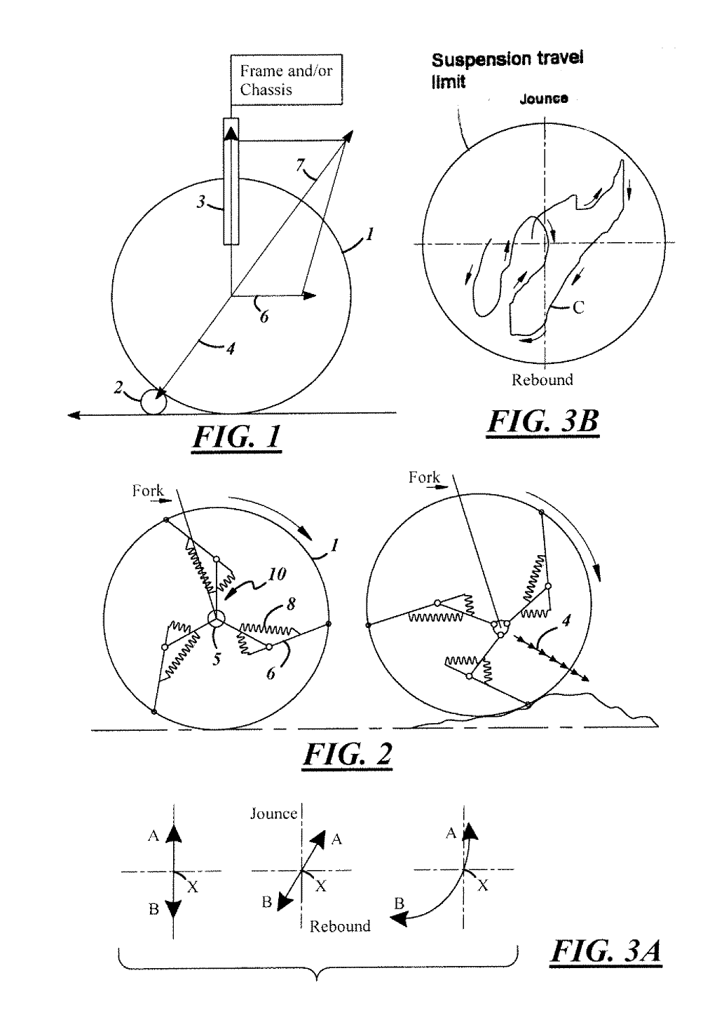

With reference to FIG. 1, this is a schematical representation of the limitations of current suspensions. Current suspensions are not fully effective at absorbing all of the energy encountered by a wheel contacting an obstacle. As can be seen in the Figure, a wheel 1 encountering an input in the nature of obstruction 2 can move only in the fixed linear path permitted by the suspension. Accordingly, while some of the energy from the impact is absorbed by the suspension's springs or shock absorbers 3, or a combination thereof, a vectored component 7 normal to impact reaction line 4 is transferred directly to the chassis along the direction line 6.

Ideally therefore, rather than a suspension that has a single or fixed path, it is preferable that the path of suspension travel when reacting to an input is the path that will best absorb the input's energy. So instead of the predetermined path of travel in a conventional system, the present reactive suspension proposes that its path of travel is actually determined by the input. This reaction is shown schematically in FIG. 2 showing a wheel 1 having a reactive planar suspension 10 where the wheel's axle 5 is resiliently supported relative to the wheel itself such as by means of pivot legs 6 and energy absorbing torsion springs S. Accordingly, upon the impact of the wheel with the input, the axle can displace itself towards the input along or nearly along the reactive line 4 for more direct absorption of the input's energy and a more comfortable, stable ride for the vehicle's occupant. The axle's ability to react to the input in the plane of the wheel's rotation allows the suspension to react dynamically as the orientation of the reaction line changes as the wheel traverses the input This is shown most clearly in FIGS. 3A and 3B, which compares the fixed linear or curved path of travel A-B of a conventionally suspended axle, which must pass through its zero load position X as it moves up (ounce) and down (rebound), and the reactive travel path C of the present suspension which allows the axle to travel any path within the suspension's travel limits. In the present suspension therefore, the axle's travel can start from any position within the travel limits and is not required or restrained to travel through the zero load position X. The zero load position of a conventional suspension is defined as the position of the suspension under static conditions when supporting the design load only.

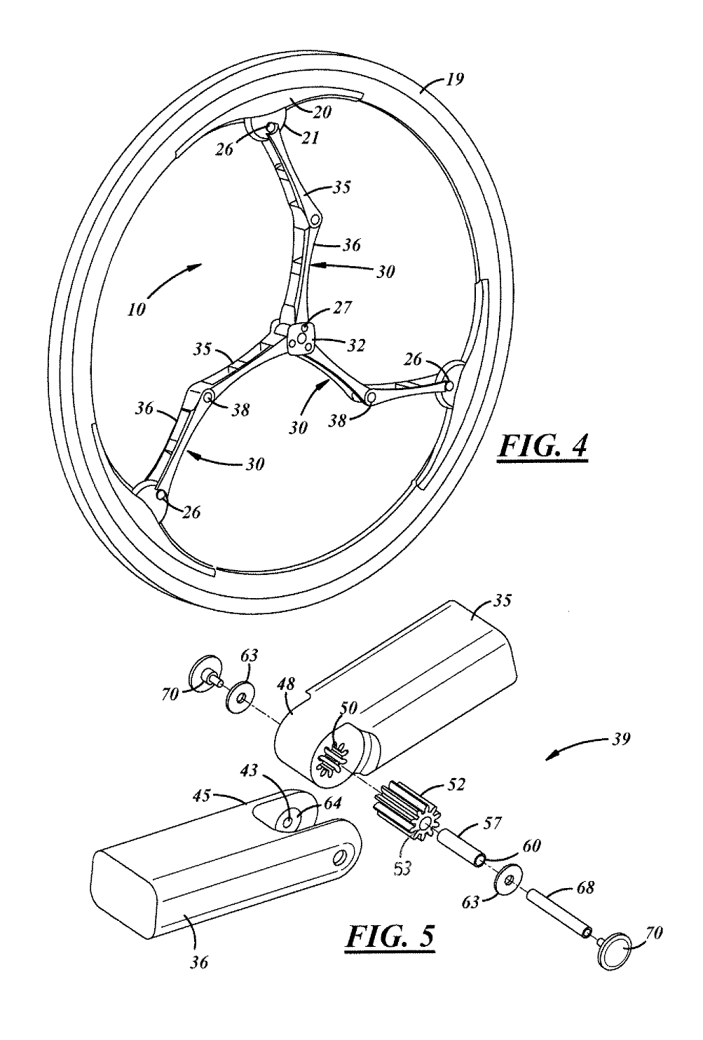

Reference will now be made to FIG. 4 showing a wheel having a reactive planar suspension 10 in accordance with one embodiment of the present invention. The wheel shown is without a tire. This wheel is preferably intended for applications such as wheelchairs, carts, trolleys and bicycles depending on their use. The inventive wheel, however, can also be utilized for many other wheeled vehicles, such as golf carts, electric vehicles, scooters, rovers and the like.

The wheel comprises an outer tire supporting rim 19 manufactured from any suitable material which will typically be a light, strong metal or moulded plastic. The inner periphery of the wheel is provided with permanently connected support yokes 20, each having a flange 21 to which respective ones of spoke-like pivot legs 30 can be connected for rotation about pivot points 26 as will be described below. The inner ends of arms 30 connect pivotably to an axle collar 32 at pivot points 27. Axle collar 32 supports the wheel's axle (not shown) and can also support the rotor of a disc brake if required, or even a drum brake. Each leg 30 comprises an outer link 35 and an inner link 36 pivotably connected to each other at pivot point 38. At least one and up to all three pivot points 26, 27 and 38 of each leg 30 can include a torsion joint that will be described below for energy absorption. If only one of the pivot points includes a torsion joint, it will preferably be pivot points 38 between links 35 and 36. In those pivot points that do not include a torsion joint, the connection to the respective ends of links 35 and 36 will normally be by means of a pin.

Reference is now made to FIG. 5 which is an exploded view of a torsion joint 39 wherein like numerals are used to identify like elements. One of inner or outer links 35 and 36 is formed with a fork 45 with axially aligned apertures 43 formed therein. The apertures are square or some other geometric shape other than round. The other of the inner and outer links 35 or 36 is formed with a knuckle 48 that fits into fork 45 for rotation relative thereto. The knuckle is formed with a transversely extending ribbed or splined aperture 50 that is shaped and sized to closely receive a correspondingly shaped and sized ribbed or splined torsion spring 52. Spring 52 is preferably made of any suitable elastically deformable rubber-like elastomeric material such as urethane. The spring 52 can also, however, be made of steel, composites, or other spring materials

Torsion spring 52 is itself formed with an axially extending aperture 53 for a metal or plastic spring sleeve 57. Sleeve 57 is permanently bonded to the torsion spring so that there is no relative rotation between the two. The sleeve is tubular and has its own longitudinally extending aperture 60 formed there through having the same non-round cross-sectional shape as apertures 43 in forks 45.

Will the assembled torsion spring and sleeve inserted into aperture 50, and nylon or Teflon washers 63 inserted into recesses 64 in forks 43 which can act as bearings, knuckle 48 can be inserted into fork 45 so that links 35 and 36 are at a predetermined angle to each other. The assembly is then completed by inserting a key 68 through the holes in the forks and aperture 60 through sleeve 57. The assembly is secured together using screws 70 that thread into opposite ends of key 68. The key's cross-sectional shape is the same as apertures 43 in fork 45 and aperture 60 through sleeve 57 so that there is no relative rotation between them. As a result, any flexure in joint 38 is absorbed and dampened by torsion spring 52. The three legs inside the wheel rim act in concert to allow axle collar 32, and the axle supported therein, to move in the axes, or “^{t}in the plane of wheel rotation” Y and Z planes relative to the wheel rim so that the axle can move in direct or near direct opposition to the reaction line from the input. This occurs as leg 30 closest to the input compresses and the legs more distant from the input lengthen. The maximum amount the axle can move is of course the amount by which the legs lengthen as they move into their straight position.

In place of or in addition to washers 63, a known motion control lock-out mechanism can be installed that can be actuated to lock pivot point 38 against rotation if the user wants to disable the suspension.

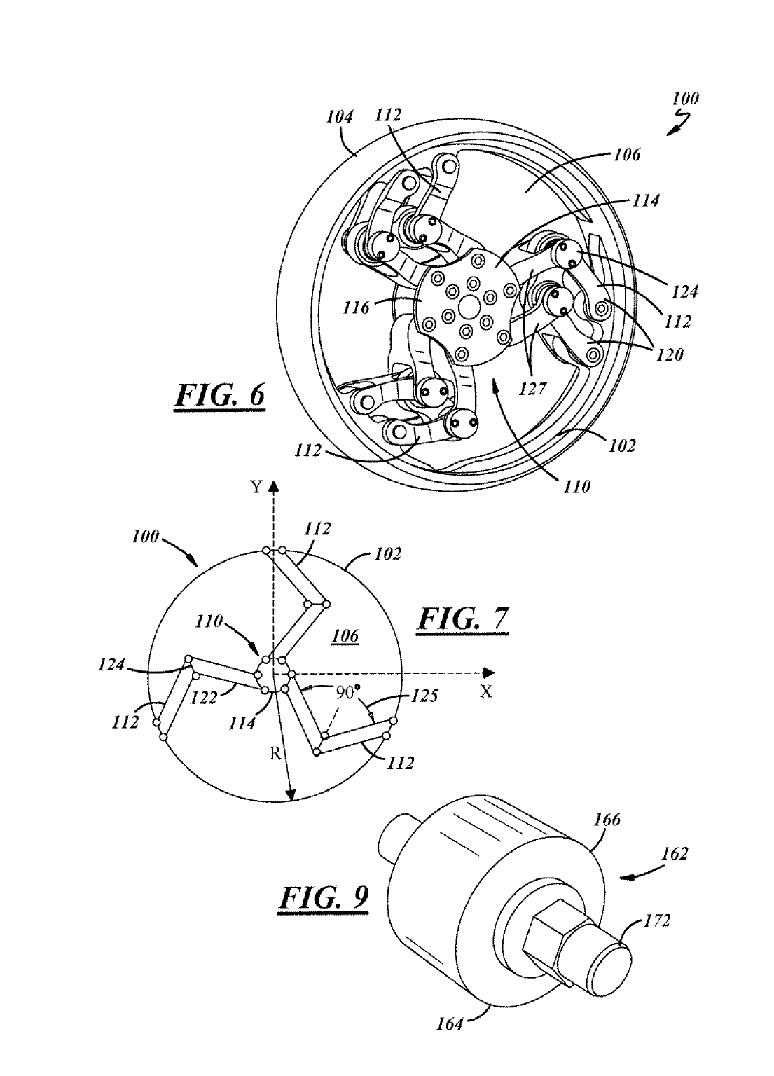

FIG. 6 depicts another wheel embodiment 100 of the present invention. This embodiment has particular use in powered wheels in which a motive or braking torque is applied to the wheel.

The wheel 100 has an outer supporting ring 102 manufactured from the same or similar materials mentioned above with respect to FIG. 4. A rubber tire member 104 is preferably positioned on the outer surface of the rim 102.

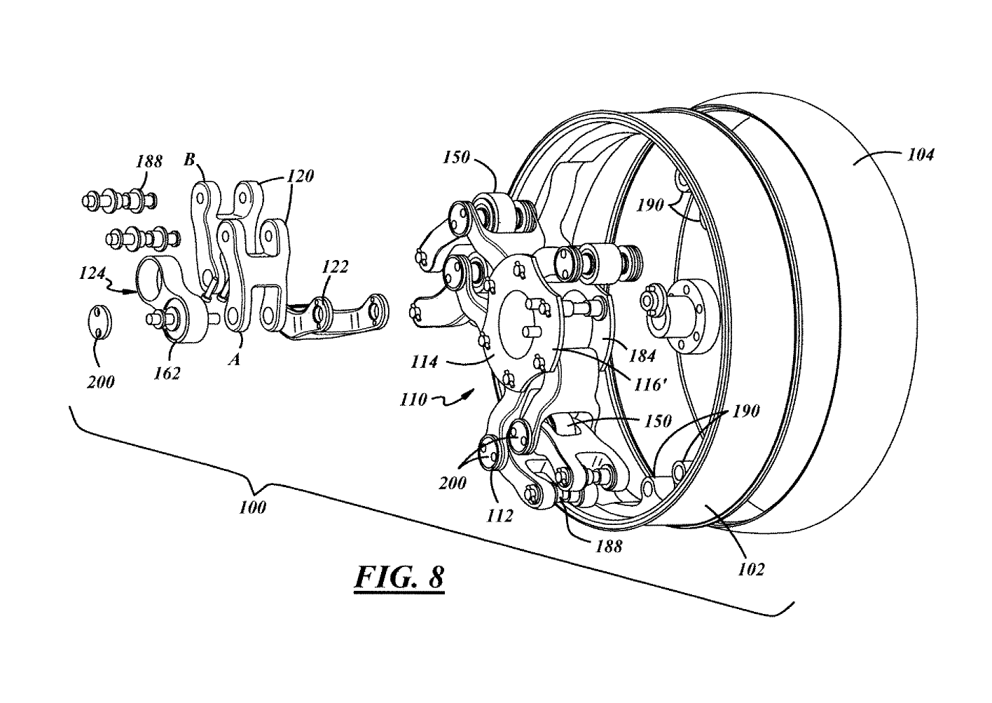

The inner portion 106 of the wheel 102 has a reactive planar suspension mechanism 10 which has three spoke-like pivot leg members 112 and a central hub member 114. The hub member 114 has a plate member 116 positioned on either side. (In the embodiment shown in FIG. 8, a different plate member 116′ is utilized.)

Each of the leg members 112 includes a lower arm member 120 and an upper arm member 122 which are pivotably connected together by pivot members 124. As better shown in FIGS. 12 and 13, the lower arm member has an “H” shape with two arms 130, 132 connected together by connecting member 134. Each of the arms has openings 140, 142 for connection to a pivot member 124 at one end A and to pivot member 150 at the other end B. At end A, the pivot member 150 pivotally connects the lower arm members 120 to the upper arm members 122. The pivot members 124 also connect both of the lower arm members 120 to each other in each set of leg members 112.

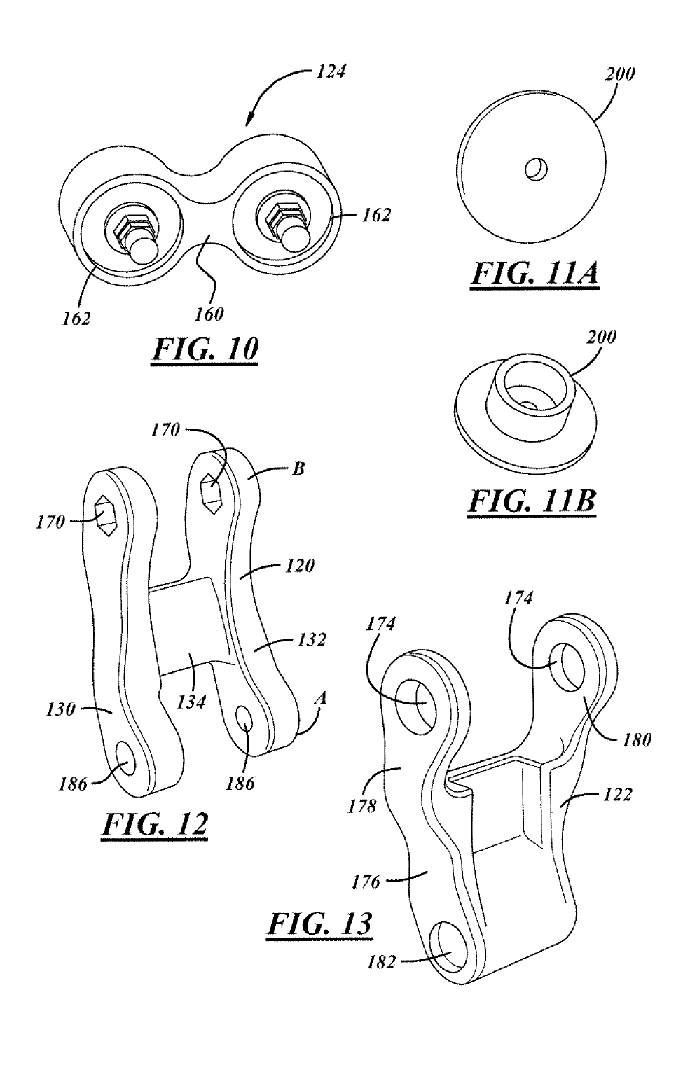

As shown in FIGS. 9 and 10, the pivot members 124 have a central body member 160 and a pair of torsion spring link members 162. The members 162 have a central core member 164 and a rubber outer annular spring member 166. The ends of the central core members 164 have hex-shaped portions 168 which mate with corresponding hex-shaped openings 170 in ends B of the upper arm members 120 (FIG. 12). The ends of the central core members 164 also have cylindrical portions 172 which mate with corresponding openings 174 in the lower arm members 122.

The upper An members have a generally U-shaped body member 176 with a pair of arms 178 and 180. The body member 176 also has a cylindrical bore 182 which is connected by pivot members 184 to the central hub member 114 (FIG. 8).

The openings 186 in ends A of the arms of the upper body member 120 are connected to the rim 102 by pivot members 188.

The inside of the rim member 102 has a plurality of support members 190 arranged in pairs and adapted to connect the pivot leg members 1 12 to the rim. The number of pairs of members 190 correspond to the number of pivot leg members. In the embodiment shown in FIGS. 6-8, three pairs of support members and three pivot leg members 112 are provided.

All of the pivot members and upper and lower leg members are made of a material which has sufficient strength and durability to perform the objects of the invention. The material can be a metal material, such as steel, or a strong and durable plastic material.

Cap members 200 as shown in FIGS. 11A and 11B are used to cover the ends of the torsion spring link members (see FIGS. 6 and 8).

FIG. 7 schematically illustrates the structure and movement of the embodiment 100 shown in FIGS. 6 and 8. The spoke-like pivot leg members 112 each comprise pairs of upper leg members 122 and pairs of lower leg members 120. The pairs of leg members are pivotally connected together by torsion spring link members 124. The opposite ends of the pairs of leg members are pivotably attached to the rim 102 of the wheel and the central hub member 110.

The lengths of the pairs of upper and lower leg members 120, 122 preferably are equal for a balanced design, but this is not necessary. Also, in order to minimize the displacement of the central hub member during rotation, the pairs of upper and lower leg members preferably meet at an angle 125 close to 90°. This angle also minimizes the horizontal displacement fluctuation during rotation.

The above-described embodiments of the present invention are meant to be illustrative of preferred embodiments and are not intended to limit the scope of the present invention. Various modifications, which would be readily apparent to one skilled in the art, are intended to be within the scope of the present invention. The only limitations to the scope of the present invention are set forth in the following claims appended hereto.

What is claimed is:

1. A suspension for a wheel rotatably mounted about an axle, comprising means to resiliently support said axle from movement in the plane of the wheel's rotation in response to an input to said wheel.

2. The suspension of claim 1 wherein said wheel comprises a rim to support a ground-engaging tire and means to rotatably support said axle, said means to support comprising a plurality of resiliently flexible legs extending between said rim and said means for rotatably supporting said axle.

3. The suspension of claim 1 wherein said wheel comprises a rim to support a ground-engaging tire and a hub for said axle disposed concentrically within said rim, said means to support being disposed within said hub.

4. A suspension for a wheel rotatably mounted about an axis, said suspension comprising a central hub member for supporting said suspension in said wheel and a plurality of resiliently flexible leg members connecting said central hub member to the rim of the wheel, each of said flexible leg members having a pair of inner leg members and a pair of outer leg members pivotably mounted together.

5. The suspension of claim 4 wherein said pairs of outer leg members are pivotably connected to the rim of the wheel and said pairs of inner leg members are pivotably connected to said central hub member.

6. The suspension of claim 4 wherein said pairs of inner and outer leg members are pivotably connected together with torsion spring link members.

7. The suspension of claim 6 wherein said torsion spring link members comprise an elastomeric energy absorbing member.

8. The suspension of claim 6 wherein said torsion spring link members comprise a metal steel member.

9. The suspension of claim 4 wherein said inner leg members comprise U-shaped members and said outer leg members comprise H-shaped members.

10. A wheel for a wheeled vehicle, said wheel having an outer rim member, a central hub member and a plurality of spoke-type leg members extending between said central hub member and said outer rim member, each of said spoke-type leg members comprising a pair of outer leg members and a pair of inner leg members.

11. The wheel of claim 10 wherein said pairs of outer leg members are pivotably connected to the rim of the wheel and said pairs of inner leg members are pivotably connected to said central hub member.

12. The wheel of claim 10 wherein said pairs of inner and outer leg members are pivotably connected together with torsion spring link members.

13. The wheel of claim 12 wherein said torsion spring link member comprise an elastomeric energy absorbing member.

14. The wheel of claim 12 wherein said torsion spring members comprise a steel metal member.

15. The wheel of claim 10 wherein said inner leg members comprise U-shaped members and said outer leg members comprise H-shaped members.
